(19) United States
(12) Patent Application Publication
(10) Pub. No.: US 2009/0096751 A1
(43) Pub. Date: Apr. 16, 2009

(54) PROJECTED CLEANABLE KEYBOARD

(75) Inventors: Graham Ross, Poway, CA (US); Mark Raptis, Valley Center, CA (US); Erich Coiner, Poway, CA (US)

Correspondence Address: MCDERMOTT, WILL & EMERY, 11682 EL CAMINO REAL, SUITE 400, SAN DIEGO, CA, 92130-2047, US

(73) Assignee: CARDINAL HEALTH 303, INC., San Diego, CA (US)

(21) Appl. No.: 11/871,566

(22) Filed: Oct. 12, 2007

(51) Int. Cl. G06F 3/02

(52) U.S. Cl. 345/168

(57) ABSTRACT

Systems and methods are described for simulating physical features of a projected keyboard in a sterile environment by incorporating a mechanical keyboard and a virtual keyboard. A keyboard projection apparatus projects light toward a mechanical keyboard. When a key is pressed, the keyboard projection apparatus tracks finger locations. User input is created by the keyboard projection apparatus and can be processed by a computer or other electrical equipment. By using an actual keyboard having simple mechanical components with the keyboard projection apparatus, the tactile feel can be realized and the keyboard can be easily cleaned or disposed of.

### STATEMENT AS TO RIGHTS TO INVENTIONS MADE UNDER FEDERALLY SPONSORED RESEARCH OR DEVELOPMENT

Not Applicable.

### CROSS-REFERENCES TO RELATED APPLICATIONS

Not Applicable.

### BACKGROUND

Virtual input devices are sometimes used to input commands and/or transfer other information to computers. One such input device is a virtual computer keyboard. The virtual keyboard is created through a projection of light on a surface. Virtual keyboards determine when a user's fingers contact the virtual input device and which virtual keys are contacted by the fingers. Pressing of the keys does not actually input information, but the interaction or interface between the user's fingers and the keys delineated by the projection of light are used to input information to the computer system. Virtual keyboards have, in many instances, eliminated the need for actual mechanical keyboards.

### SUMMARY

Virtual keyboards can be used in hospitals, which require a sterilized environment, or in other words, an environment that is substantially free from germs or viruses. Through the use of the virtual keyboard, the surface on which the keyboard is projected can be easily cleaned. For example, between shifts of a caregiver, the surface upon which the keyboard is projected can be sprayed or wiped down with sterilizing fluids to remove any contaminants, bioproducts, or other unwanted residue that may accumulate upon a surface that is touched by either the patient or the caregiver.

The use of a virtual keyboard is an improvement over other physical, or mechanical, keyboards, which can permit the accumulation of undesirable products between or beneath the keys of the keyboard. In some instances, a thin cover is placed over a mechanical keyboard in an attempt to prevent such products from accumulating inside the keyboard. However, the keyboards can still accumulate unwanted products over time in places that are not properly cleaned or wiped. Moreover, the cover often impedes typing by the users, as it is often difficult to decipher which key is being depressed without looking at the keyboard.

The innovation of the virtual keyboard has been fueled by a strong desire to eliminate the need of an actual mechanical keyboard, which can be considered bulky and cumbersome. With the virtual keyboard, phones and personal handheld devices can receive input in a manner that is much easier than using miniature keyboards on the device itself or collapsible keyboards that are connected to the device. For purposes of transportability of a keyboard to be used with personal handheld devices, the virtual keyboard provides portability and convenience.

However, for many reasons explained herein, continual use of the virtual keyboard alone may present overriding drawbacks that may limit wide acceptance of the virtual keyboard in the medical industry. For example, virtual keyboards lack the tactile or tangible feel that many are accustomed to having when using a mechanical keyboard. When using a mechanical keyboard, the user is able to feel and know the location of each key without depressing the key or without looking at the keyboard. However, the visual keyboard does not provide the tactile feel that indicates to the user the location of the keys. The user of the visual keyboard is required to continually look down at the projection of the keyboard and visually locate the key that is to be pressed. This can be difficult if the user is trying to copy information from another document and has to repeatedly switch attention from the document to the keyboard. Continual use of the visual keyboard in this manner can possibly result in neck or back problems.

Another concern with the virtual keyboard is that the keyboard is projected onto a hard, flat surface. While this makes it convenient for cleaning, the hard, flat surface is not ergonomically suitable for the hands. For example, when a user hits a key to input information into the computer, the user's finger strikes the hard, flat surface. The user is often accustomed to depressing a key on a mechanical keyboard that provides a degree of resistance while the key is being depressed, thus reducing the impact of the finger on the key. Repeated use of the virtual keyboard on the hard, flat surface can possibly result in sore fingertips or other complications with the fingers and wrists.

Yet another concern about the virtual keyboard is that the projected keyboard is often difficult to see when used in full light. The light is projected onto a surface that the user views to determine where to press to input a key stroke. However, when in a room, or outside, where there is a sufficient amount of light, the keyboard projected onto the surface can be hard to decipher. Accordingly, several applications of the virtual keyboard take place in darkened rooms.

Disclosed herein are embodiments of a new virtual keyboard system that overcomes at least the above-mentioned shortcomings of the above-described virtual keyboards. While the virtual keyboard was designed to eliminate the need of a mechanical keyboard, and as the industry has been moving to smaller, compact keyboards, disclosed herein is a system that incorporates a mechanical keyboard and a virtual keyboard. In some embodiments described herein, a virtual keyboard is projected onto a mechanical keyboard, and the virtual keyboard detects when keys of the mechanical keyboard are depressed. While the virtual keyboard would otherwise obviate the use of a mechanical keyboard, and combining the two would appear illogical given the functions and purposes of each, it has been found that combining a virtual keyboard with a mechanical keyboard has several advantages.

For example, using a virtual keyboard projected onto a mechanical keyboard eliminates any need for the mechanical keyboard to contain electrical components. Accordingly, the mechanical keyboard can be devoid of electrical components, thus allowing the keyboard to be sterilized or otherwise washed for cleaning, such as, for example, in a dishwasher or fully submersible in cleansing agents. Additionally, there is also no concern about liquid spilling on the keyboard because, without electronics, the mechanical keyboard is much less likely to be damaged by liquid.

The combined system also provides tactile indication of the keys on the keyboard, which correspond to those projected by the virtual keyboard system. The user is able to use the mechanical keyboard like any other keyboard, and the virtual keyboard system detects actuation of the keys for inputting the information into, for example, a computer. Because the user is able to feel and locate the keys without looking down at the keyboard, the system makes it easier to copy information from a document or separate screen, as the user can focus attention on the document instead of trying to identify the location of the key to be pressed. Moreover, the mechanical keyboard can provide the normal depression function and reduce the impact force that is experienced when a user strikes a key of the virtual keyboard on a flat, hard surface. Furthermore, the mechanical keyboard can be used in any type of light. In dark environments, the keyboard can be illuminated by the projection of the keyboard, and in light environments, the mechanical keyboard can include printed markings to provide indication of the keys.

Disclosed herein are further embodiments of a system for simulating physical aspects of a keyboard for a virtual keyboard projection. As explained above, by using a keyboard having simple mechanical components along with the virtual keyboard projection, a user can be provided with the tangible feel of a keyboard. Further, the system can provide a sanitized environment because of the simple mechanical components of the physical keyboard component of the system.

In accordance with certain embodiments, a system for inputting information is presented. The system preferably includes a physical keyboard having a plurality of actionable keys. A projector is configured to project light toward the actionable keys on the physical keyboard. When a key is depressed, a detector that is configured to obtain user input detects interference in the projected light.

According to some embodiments, a method for inputting information is presented. The method preferably includes projecting light toward a keyboard having a plurality of actionable keys. By projecting light towards the keyboard, the method can obtain user input by detecting interference in the projected light when the actionable keys of the keyboard are depressed.

Additional features and advantages of the invention will be set forth in the description below, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 is an exemplary known system for receiving user input through a virtual keyboard projection on a work surface in accordance with certain embodiments of the present invention.

FIG. 2A is an embodiment of a system using a keyboard projection apparatus to display icons on a physical keyboard and to detect key presses on the physical keyboard in accordance with embodiments of the present invention.

FIG. 2B is an embodiment of a system using a keyboard projection apparatus to display icons on a physical keyboard and to detect key presses on the physical keyboard in accordance with embodiments of the present invention.

FIG. 3 is an exploded view illustrating internal components of a physical keyboard in accordance with certain embodiments of the present invention.

FIG. 4A depicts a physical keyboard showing sets of icons displayed from a keyboard projection apparatus in accordance with embodiments of the present invention.

FIG. 4B depicts a physical keyboard showing sets of icons displayed from a keyboard projection apparatus in accordance with embodiments of the present invention.

### DETAILED DESCRIPTION

Disclosed herein are embodiments of a new virtual keyboard system that provides several advantages over other keyboards. In some embodiments described herein, an input system incorporates a mechanical keyboard and a virtual keyboard. In certain embodiments, a virtual keyboard is projected onto a mechanical keyboard. The virtual keyboard component includes sensors that detect when keys of the mechanical keyboard are depressed. Combining a mechanical keyboard and a virtual keyboard eliminates the need for the mechanical keyboard to contain electrical components. Thus, the keyboard can be sterilized, or otherwise washed, for example, in a dishwasher or submersed in cleansing agents. As mentioned, the combined system also provides tactile indication of the keys on the keyboard, which correspond to those projected by the virtual keyboard system. The user is able to use the mechanical keyboard like any other keyboard, and the virtual keyboard system detects actuation of the keys for inputting the information into, for example, a computer. The disclosed virtual keyboard system can also be used in several environments, illuminated or dark. Such a virtual keyboard system can be used advantageously in clean environments, such as, for example, hospitals and other care or research facilities.

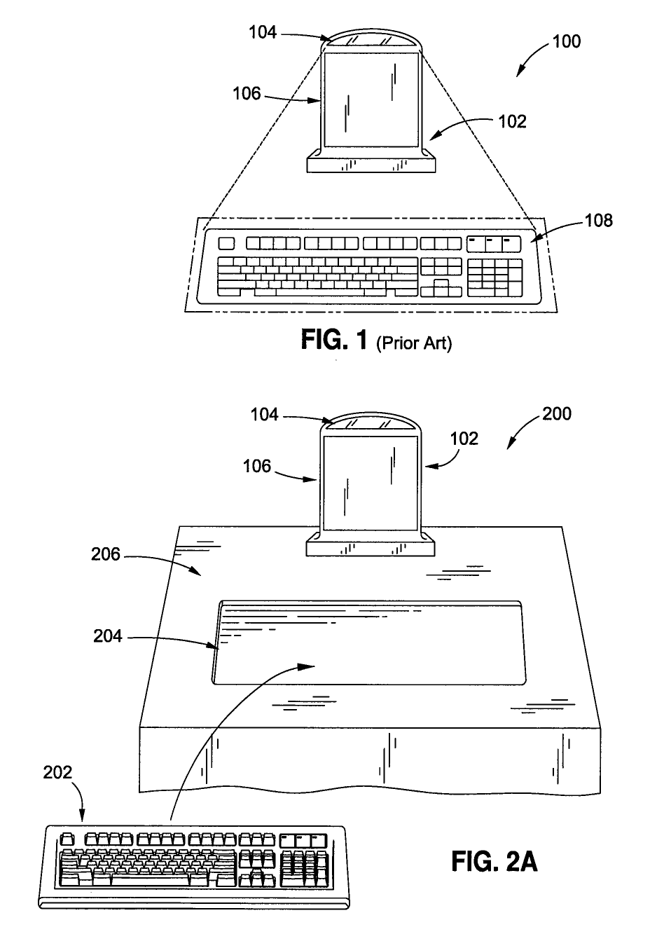

Now referencing FIG. 1, an exemplary known system 100 for receiving user input through a virtual keyboard projection on a work surface is presented. As shown, the system 100 includes a keyboard projection apparatus 102 that creates a virtual keyboard 108 by projecting the image of a keyboard onto a flat surface. The keyboard projection apparatus 102 detects user key presses from the virtual keyboard 108 to receive user input. The virtual keyboard projection system 100 is intended to eliminate the need for a physical keyboard to input information into a computer or other electronic device. Among other things, the virtual keyboard eliminates the unsightly appearance that a physical keyboard attached to a computing device presents. The virtual keyboard also provides an easy and small portable device that functions as a keyboard. Moreover, in environments where sterility can be important, the virtual keyboard can be used to eliminate the need for a physical keyboard and prevent the accumulation and transfer of contaminants that are often associated with a physical keyboard. Such contaminants often accumulate between and underneath the keys of a conventional keyboard. However, while the virtual keyboard system 100 is intended to eliminate the need for a physical keyboard, embodiments of the invention later described provide a virtual keyboard system that incorporates a virtual keyboard with a mechanical keyboard.

The known keyboard projection apparatus 102 of FIG. 1 has two separate components: a projection device 104 and a scanning device 106. As shown, the projection device 104 and the scanning device 106 are preferably placed within the same apparatus. In some embodiments (although not shown), the projection device 104 and the scanning device 106 can be placed in different apparatuses. One of ordinary skill in the art would appreciate that as long as the projection device 104 and scanning device 106 can perform their associated functions, placement of the respective components of the keyboard projection apparatus 102 is irrelevant. For embodiments in which the projection device 104 is separate from the scanning device 106, the system may need to be calibrated or aligned to ensure that the scanning device 106 is coaligned with the projection device 104.

The projection component 104 of the keyboard projection apparatus 102 displays the virtual keyboard 108 onto a surface. The surface can be a tabletop, a desk, or similar consistent surface so that images can appear. To project the virtual keyboard 108 on the surface, visible light can be used. When visible light is used, the projection of the keyboard 108 by the projection component 104 can be beams of light, lasers, or any other way of projecting visible light. In one embodiment, the projection component 104 is directly in front of the virtual keyboard 108. Alternatively, the projection component 104 can be positioned from behind the virtual keyboard 108. Still yet, the projection component 104 can be positioned above or beneath the virtual keyboard 108.

With continued reference to FIG. 1, the keyboard projection apparatus 102 also includes a scanning device 106 for tracking virtual “keys” pressed by the user. To retrieve information on which virtual key was pressed on the virtual keyboard 108, the scanning device 106 preferably has multiple sensors and emitters. In certain embodiments, the scanning device 106 has two laser emitters. The first laser emitter performs a surface scan to generate the patterns of the keyboard 108, while the second laser emitter simultaneously generates a first reflective beam and a second reflective beam when the user enters input using the virtual keyboard 108. The scanning device 106 detects reflection angles of light reflected by fingers of the user. Combining the angles measured by the two sensors, the system can determine, by triangulation, the position of the virtual key pressed. In some embodiments, the information retrieved by the two sensors is used to form a three-dimensional image, which is analyzed by a processor to determine the location of the user's fingers. After the input is received, the signals are sent to a computer, or other digital or electronic device, for processing. One skilled in the art would recognize that many forms of sensory technology exist. For example, certain scanning devices 106 use optical systems. Alternatively, a scanning device can use reflected energy, removing the need for ambient light.

Because the system, as described above, does not provide a physical keyboard, the user can not determine with certainty whether a key has been pressed without visually processing information on a monitor. Further, the user cannot locate by touch a key on the projected keyboard. Because there is no tactile feel to the virtual keyboard of FIG. 1, the user would have to look at the keyboard 108 to determine where to appropriately place their fingers. Additionally, the requirement to visualize the projected keyboard can impede use of a projected keyboard by someone who is blind or physically unable to adjust their sitting arrangement to view the projected keyboard. Still further, it may be difficult for the keyboard projection system 100 to distinguish between when the user intends to press a key and when the user merely rests their hands on the surface upon which the visual keyboard is projected.

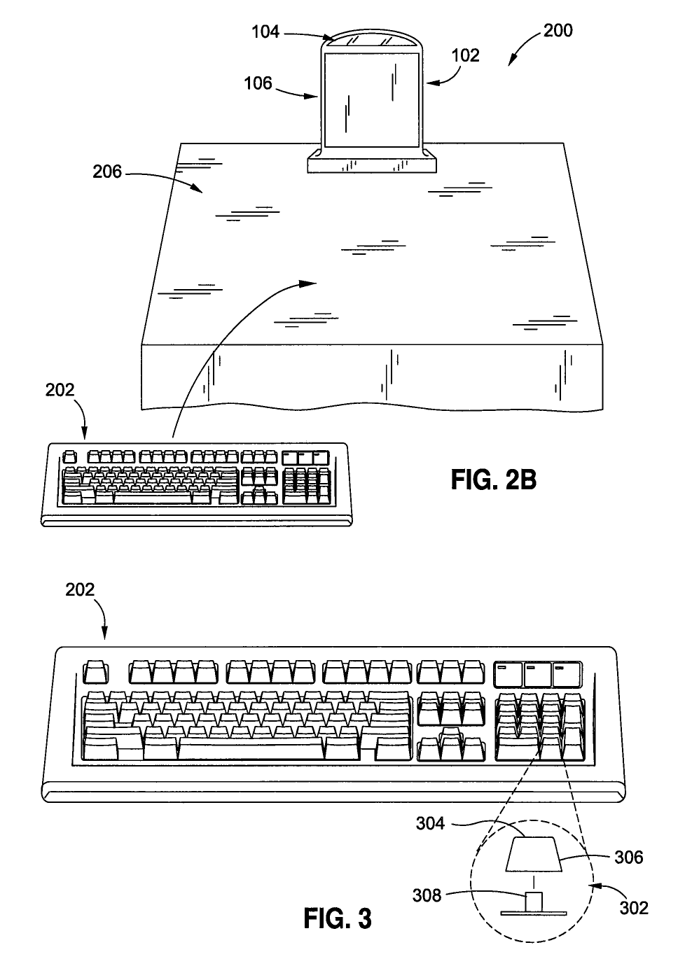

The present disclosure relates to a system that incorporates utilizing physical features with the projection system 102. Such a system can facilitate, among other things, maintaining a sterile environment, as explained above with respect to FIG. 1. Now referencing FIGS. 2A and 2B, embodiments of systems using a projection system 102 in combination with a physical keyboard 202 are presented. Advantageously, the physical keyboard 202 allows users to determine with certainty whether a key has been pressed without visually processing information on a monitor or having to look down at the keyboard to press the key. Key presses are preferably accurately detected as the physical keys of the physical keyboard 202 are depressed during use. Further, the user can locate desired keys by touch, as with other physical keyboards. Appropriate markings on the physical keyboard 202 can also provide the user with key locations, although in certain embodiments, the markings are projected onto the physical keyboard 202.

The embodiments of the systems 200 of FIGS. 2A and 2B preferably include a keyboard projection apparatus 102 that can be similar to the aforementioned device of FIG. 1. In addition, the systems in the embodiments depicted in the FIGURES include a separate mechanical keyboard 202 that provides the physical or tactile aspect of the systems 200. There is preferably no connection between the keyboard 202 and the projection apparatus 102, nor any other systems. The keyboard 202 is preferably used to present a user with physical aspects of a keyboard, but does not contain the electrical components of other physical keyboards that are coupled to a computer for providing input into the computer.

In certain embodiments, the keyboard 202 refers to a keyboard incorporating the keys and orientation of keys that correspond to those of standardized keyboards. In some embodiments, the keyboard projection apparatus 102 does not need to conform its settings to the layout of the keyboard 202 because a single shape and size of keyboard is used with the system. In further embodiments, the keyboards 202 can be different shapes and sizes, and the keyboard projection apparatus 102 can be configured to detect which keyboard 202 is being used and correlate that to the keys that are depressed on the keyboard 202. In embodiments that are configured to use keyboards of various shapes and sizes, the keyboard projection apparatus 102 preferably adjusts the settings to the size and specifications by performing an initial scan of the keyboard 202 or by some other identification process.

With reference to FIG. 2A, a system 200 having a detached keyboard 202 within a known location is presented. As shown, the keyboard 202 is preferably configured to be properly positioned by a keyboard locator 204. The keyboard locator can include a recess, as depicted in FIG. 2A, into which the keyboard 202 is placed or protrusions upon a surface 206 against which the keyboard 202 is pressed for proper alignment with the keyboard projection apparatus 102. In further embodiments, portions of the keyboard 202 may be configured to reside in slots or depressions in the surface 206 and in which the keyboard 202 is placed. Accordingly, the keyboard 202 is properly oriented with the keyboard projection apparatus 102, and the projection apparatus 102 will require little or no adjustments to the settings when the keyboard 202 is replaced.

In the embodiments depicted in FIG. 2A, the keyboard 202 is placed into the keyboard locator 204, and the keyboard projection apparatus 102 can detect that a keyboard has been placed in the locator 204 or the user can provide other instructions to the apparatus 102 to indicate that the keyboard 202 has been provided and is properly oriented by the locator 204. The projection device 104 is preferably activated to provide the virtual keyboard, and the scanning device 106 is used to detect depression or actuation of the keys of the mechanical keyboard 202.

While embodiments depicted in FIG. 2A illustrate the projection device 104 as above the scanning device 106, in some embodiments, the projection device 104 and the scanning device 106 are positioned in substantially the same plane. In further embodiments, the projection device 104 is positioned below the scanning device 106. Moreover, as explained above, although the scanning device 106 is depicted as a single unit, the scanning device 106 can include a plurality of sensors that are configured to detect interference in light emitted by the projection device 104 and triangulate the location of the interference. Furthermore, although the keyboard projection apparatus 102 is depicted as being in front of the keyboard 202 or the keyboard locator 206, in some embodiments, the keyboard projection apparatus 102 is positioned on the sides, behind, above, or underneath the keyboard 202 or the keyboard locator 206.

Now referring to FIG. 2B, embodiments of a system 200 having a separate keyboard 202 placed anywhere on a surface 206 are presented. In these embodiments, the keyboard projection apparatus 102 searches for the detached keyboard 202. When the keyboard 202 is positioned on the surface 206, the keyboard projection apparatus 102 is preferably configured to detect the position and orientation of the keyboard on the surface 206. This can be accomplished by the keyboard including markers or indicia that can be detected by the scanning device 106, which is then used to identify the position and orientation of the keyboard 202. In further embodiments, the keyboard projection apparatus 102 does not require markers or indicia for locating the keyboard 202. In some embodiments, the keyboard projection apparatus 102 operates to image or detect corners or borders of the keyboard 202 by utilizing the projection device 104 in conjunction with sensors of the scanning device 106. Once the keyboard projection apparatus 102 has detected the presence of the keyboard 202 and determined the proper position and orientation of the keyboard 202, the keyboard projection apparatus 102 preferably focuses the projection device 104 and scanning device 106 on the detached keyboard 202. After focusing the devices 104, 106, the keyboard projection apparatus 102 preferably continues with its normal operation of projection a virtual keyboard onto the mechanical keyboard and detecting depression or actuation of the keys of the mechanical keyboard.

Although the embodiments explained above with respect to FIGS. 2A and 2B can operate similar to other virtual keyboards, the embodiments can incorporate additional features. For example, in some embodiments, the projection device 104 is configured to project light onto the top of the keyboard 202 and the scanning device 106 is configured to detect interference in this light that corresponds to when a user depresses a key of the keyboard 202.

In further embodiments, the projection device 104 is configured to provide a projection of light under the keyboard 202, which projection of light may be substantially parallel to the bottom surface of the keys of the keyboard 202. Accordingly, depression of the keys is detected by interference of the light being emitted along the bottom of the keys of the keyboard 202. For example, in some embodiments, the projection device 104 comprises a plurality of light sources, or emitters, that project light toward the keyboard 202. In some embodiments, light is projected onto a top surface of the keyboard 202, and in some embodiments, light is projected underneath the bottom surface of the keyboard 202. In some embodiments, light is projected both onto the top surface and underneath the bottom surface of the keyboard 202.

In some embodiments, the light that is projected is visible light, and in further embodiments non-visible light is projected toward the keyboard 202. Visible light can be used in a manner similar to that described above. In some embodiments, visible light is projected toward the keyboard, and it can be projected onto the top surface of the keys of the keyboard or underneath the keys of the keyboard. When non-visible light is used, the projection onto the surface would be even less detectable by the user, and be can used to reduce any distracting effects of the light. Such non-visible light can include ultra-violet light or infrared light.

Interference of light patterns that are projected underneath the keys of the keyboard 202 can be detected in any number of ways. For example, the location of the interference can be triangulated in a similar manner in which the location of the interference is located above the keys of the keyboard 202. In some embodiments, the light is projected just below the bottom of the key, such that when the key is depressed, the light pattern is disturbed. In some embodiments, detection of the interference can be facilitated by modification of the key itself. For example, in some embodiments, the keys may include a reflective material that is configured to deflect the light that is emitted underneath the keyboard when the key is depressed. In some embodiments, the reflective material includes a filter that limits the frequency of light reflected. When light with multiple wavelengths is used to detect the depression or actuation of a key, each key, or a series of keys, can have a unique filter that only reflects light of a certain wavelength. When light is deflected with a corresponding wavelength, the scanning device 106 can identify which key was depressed.

With reference now to FIG. 3, the keyboard 202 of FIGS. 2A and 2B having simple mechanical components is illustrated. The keyboard 202 is associated with a number of keys 302. Each key 302 is associated with a front portion 304 and back portion 306. Connected to the back portion 306 of the key 302 is a spring device 308 which allows the key 302 to return to its normal position after being pressed. In some embodiments, the spring device 308 biases the key 302 to an upward position, thus resisting depression of the key 302. In further embodiments, the spring device 308 comprises a reflective material that is utilized for facilitating detection of key depression, as explained above.

For purposes of providing the user with comfortability of use, in certain embodiments, the spring device 308 is configured to replicate the feel of a conventional keyboard when a key 302 is depressed. The depressability of the keys also allows accurate detection of key presses by the keyboard projection apparatus 102 Further, the individually separated keys 302 create defined tactile boundaries allowing the user to position their hands on the keyboard by touch rather than sight.

The keyboard 202 can be washed or disposed of because each key 302 of the keyboard 202 uses simple mechanical parts and does not contain electrical components therein. Moreover, as opposed to dummy keyboards, the keyboard systems disclosed herein have fully functioning actuatable keys that replicate the natural feel experienced with conventional keyboards. In certain embodiments, the keyboard 202 can be washed with computer cleaning materials. In other embodiments, the keyboard 202 can be washed with household cleaners. In other embodiments, the keyboard 202 is sterilized by other methods. For example, in some embodiments, the keyboard 202 can be immersed in cleansing fluids or agents during a sterilization process. Although the present disclosure provides embodiments of a keyboard 202 having only mechanical parts, one skilled in the art would understand that the keyboard 202 can also have electrical parts that are resistant to liquids or cleaning agents. However, in use, the electrical parts would have no function in inputting data.

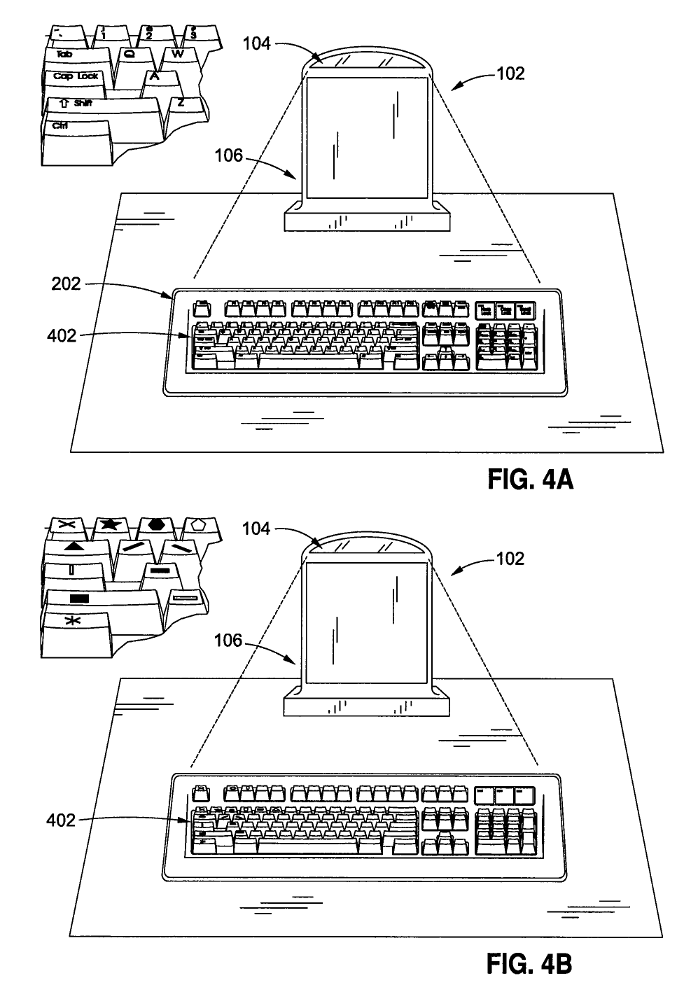

Now referring to FIG. 4A, in some embodiments, multiple icons 402 can be displayed on the keyboard 202. The icons 402 are displayed from the projection component 104 of the keyboard projection apparatus 102 and can be changed in response to user input. Because there is a physical keyboard 202, the projection component 104 does not need to define the separation of the keys. In other embodiments, the icons can be etched or printed on the keyboard 202.

As shown, the icons can represent generally accepted icons 402 such as letters of the English language. As shown in FIG. 4B, the keyboard 202 can also include a variety of icons 402 that can be changed on the keyboard 202. As an example, the icons 402 can represent Chinese characters, Hebrew, etc. Accordingly, the only required change would be the projection component 104 displaying different icons 402 when requested by the user through a set of keys on the keyboard 202.

The description of the invention is provided to enable any person skilled in the art to practice the various embodiments described herein. While the present disclosure has been particularly described with reference to various figures and embodiments, it should be understood that these are for illustration purposes only and should not be taken as limiting the scope of the disclosure. There may be many other ways to implement the embodiments of the disclosure. Various modifications to these embodiments will be readily apparent to those skilled in the art, and generic principles defined herein may be applied to other embodiments. Thus, many changes and modifications may be made to the invention, by one having ordinary skill in the art, without departing from the spirit and scope of the disclosure.

What is claimed is:

1. A system for inputting information, the system comprising:
a physical keyboard having a plurality of actionable keys;
a projector that is configured to project light toward the actionable keys; and
a detector that is configured to obtain input from a user by detecting interference in the projected light when the actionable keys are depressed.

2. The system of claim 1, wherein the physical keyboard comprises no electronic components.

3. The system of claim 1, wherein projector comprises a plurality of light sources that project light toward the keyboard.

4. The system of claim 3, wherein at least one light source projects light under the actionable keys.

5. The system of claim 1, wherein the detector comprises a plurality of sensors that detect interference in the projected light when an actionable key is depressed.

6. The system of claim 5, further comprising a processor that processes information from the plurality of sensors to triangulate the location of a depressed key and to identify which key is depressed.

7. The system of claim 5, wherein the plurality of sensors are configured to detect interference in light that is projected under the actionable keys.

8. The system of claim 1, wherein the plurality of actionable keys comprise a reflective material that deflect light projected under the actionable keys when an actionable key is depressed.

9. The system of claim 8, wherein the reflective material comprises a filter that limits the frequency of light deflected by incidence with the reflective material.

10. The system of claim 1, wherein the projector is configured to project a set of icons on the actionable keys.

11. The system of claim 10, wherein at least one projected icon corresponds to each actionable key.

12. The system of claim 10, wherein the set of icons comprise at least one of numeric, alphabetic, symbolic, and functional inputs.

13. The system of claim 10, wherein a processor is configured to alter the projected set of icons based on user input.

14. The system of claim 13, wherein the user input comprises depression of at least one of the actionable keys.

15. The system of claim 1, wherein the projector comprises a visible light source.

16. The system of claim 1, wherein each key of the plurality of actionable keys on the keyboard comprises a front portion, a back portion coupled to the front portion; and an attachment device coupled to the back portion, wherein the attachment device comprises a biasing member that resists depressing of the key.

17. A method for inputting information, the method comprising:
projecting light toward a keyboard having a plurality of actionable keys; and
obtaining user input by detecting interference in the projected light when the actionable keys are depressed.

18. The method of claim 17, wherein projecting light toward a keyboard comprises directing a plurality of light sources toward the keyboard.

19. The method of claim 17, further comprising directing the projected light under the actionable keys.

20. The method of claim 19, wherein detecting interference comprises deflecting the projected light under the actionable keys.

21. The method of claim 17, wherein detecting interference in the projected light comprises detecting interference with a plurality of sensors.

22. The method of claim 21, wherein detecting interference with the plurality of sensors comprises configuring the sensors to detect interference in light that is projected under the actionable keys.

23. The method of claim 21, wherein detecting interference in the projected light with a plurality of sensors comprises triangulating the location of a depressed key and identifying which key is depressed.

24. The method of claim 17, wherein the method for inputting information further comprises projecting a set of icons on the actionable keys.

25. The method of claim 24, wherein projecting the set of icons on the actionable keys further comprises altering the projected set of icons based on user input.

26. The method of claim 17, further comprising submersing the keyboard in a cleansing agent and providing the keyboard for use following submersion in the agent.
